(19) United States
(12) Patent Application Publication
(10) Pub. No.: US 2022/0084505 A1
(43) Pub. Date: Mar. 17, 2022

(54) COMMUNICATION BETWEEN DEVICES IN CLOSE PROXIMITY TO IMPROVE VOICE CONTROL OF THE DEVICES

(71) Applicant: Hi Auto Ltd, Tel Aviv (IL)

(72) Inventors: Roy BAHARAV, Tel Aviv (IL); Eyal SHAPIRA, Kiryat Ono (IL); Yaniv SHAKED, Binyamina (IL); Yoav RAMON, Tel Aviv (IL)

(73) Assignee: Hi Auto Ltd, Tel Aviv (IL)

(21) Appl. No.: 17/022,182

(22) Filed: Sep. 16, 2020

(51) Int. Cl. G10L 15/08; G10L 25/78; G06F 3/16; H04L 29/08

(52) U.S. Cl. CPC G10L 15/08; G10L 25/78; G10L 2025/783; H04L 67/125; G10L 2015/088; G06F 3/167

(57) ABSTRACT

A voice-controlled device, comprising at least one hardware processor adapted for receiving a set of preferred local commands or computing thereof by receiving from at least one other voice-controlled device a set of used commands and identifying in a plurality of voice commands a set of preferred local commands not members of the set of used commands; and responding to at least one voice command, received from a user, subject to identifying the at least one voice command in the set of preferred local commands, otherwise declining to respond thereto.

### FIELD AND BACKGROUND OF THE INVENTION

Some embodiments described in the present disclosure relate to a voice user interface and, more specifically, but not exclusively, to speech recognition.

A voice-controlled device is a computerized device having a voice user interface, allowing spoken user interaction therewith. A voice user interface may include speech recognition to understand one or more spoken commands. A voice-controlled device may respond to the one or more spoken commands. For example, a home ambiance control device may turn on a light in response to a spoken command. In another example, a phone may dial an identified number in response to another spoken command. In yet another example, a vending kiosk may add one or more items to a digital shopping cart in response to yet another spoken command.

For brevity, henceforth the term device is used to mean a voice-controlled device, and the terms are used interchangeably. In addition, unless noted otherwise henceforth the terms “command” and “voice command” are used to mean a spoken command, and the terms are used interchangeably. In the following description the terms speaking a command, saying a command and uttering a command are all used to mean producing an audible command by a user and are used interchangeably.

A voice command may be initiated by a user, for example to start an interaction with a device. A voice command may be a response to a question or a request posed by the device. For example, the device may present to the user a numbered list of items and pose the question: “Which item would you like to choose?” and a user may respond by uttering the command “three”, or the command “book”. Some voice user interfaces use a text display to present the user with a response or a request. Some voice user interfaces use audio to present the user with the response or the request.

A voice user interface of a device typically comprises one or more audio sensors, for example one or more microphones. The device may process an audio signal captured by the one or more audio sensors for the purpose of identifying one or more voice commands directed at the device.

### SUMMARY OF THE INVENTION

Some embodiments of the present disclosure describe a system and a method for managing, and additionally or alternatively operating, a plurality of voice-controlled devices to reduce interference with operation of one of the plurality of voice-controlled devices by one or more commands directed at another of the plurality of voice-controlled devices.

The foregoing and other objects are achieved by the features of the independent claims. Further implementation forms are apparent from the dependent claims, the description and the figures.

According to a first aspect of the invention, a voice-controlled device comprises at least one hardware processor adapted for: receiving from at least one other voice-controlled device a set of used commands; identifying in a plurality of voice commands a set of preferred local commands not members of the set of used commands; and responding to at least one voice command, received from a user, subject to identifying the at least one voice command in the set of preferred local commands, otherwise declining to respond thereto. Identifying the set of preferred local commands not members of the set of used commands reduces a likelihood of the device identifying another command not directed thereto and thus increases accuracy of the device identifying a command received from a user and directed thereat.

According to a second aspect of the invention, a method for a voice-controlled device comprises at least one hardware processor adapted for: receiving from at least one other voice-controlled device a set of used commands; identifying in a plurality of voice commands a set of preferred local commands not members of the set of used commands;

and responding to at least one voice command, received from a user, subject to identifying the at least one voice command in the set of preferred local commands, otherwise declining to respond thereto.

According to a third aspect of the invention, a vending device comprises at least one hardware processor connected to at least one audio sensor and adapted for: receiving from at least one other vending device a set of used commands; identifying in a plurality of voice commands a set of preferred local commands not members of the set of used commands; and subject to identifying at least one voice command, received from a user via the at least one audio sensor, in the set of preferred local commands, adding an item to a list of items selected by the user, otherwise declining to respond thereto.

According to a fourth aspect of the invention, a system for managing a plurality of voice-controlled devices comprises at least one hardware processor adapted for: configuring a first voice-controlled device of the plurality of voice-controlled devices to execute at least one operation in response to at least one of a first set of preferred local commands identified in a plurality of voice commands, and configuring a second voice-controlled device of the plurality of voice-controlled devices to execute the at least one operation in response to at least one other of a second set of preferred local commands identified in the plurality of voice commands; where the at least one of the first set of preferred local commands is different from the at least one other of the second set of preferred local commands. The first set of preferred local commands being different from the second set of preferred local commands increases accuracy of one or more responses of the first voice-controlled device and the second voice-controlled device as the second voice-controlled device may not respond to a command directed to the first voice-controlled device and the first voice-controlled device may not respond to another command directed to the second voice-controlled device.

According to a fifth aspect of the invention, a method for managing a plurality of voice-controlled devices comprises: configuring a first voice-controlled device of the plurality of voice-controlled devices to execute at least one operation in response to at least one of a first set of preferred local commands identified in a plurality of voice commands, and configuring a second voice-controlled device of the plurality of voice-controlled devices to execute the at least one operation in response to at least one other of a second set of preferred local commands identified in a plurality of voice commands; where the at least one of the first set of preferred local commands is different from the at least one other of the second set of preferred local commands.

In an implementation form of the first and second aspects, each of the plurality of voice commands has a recognition score indicative of a likelihood of the voice-controlled device recognizing the voice command, and the at least one hardware processor is further adapted for: computing a plurality of confusion scores, each indicative of a likelihood of confusion between a pair of voice commands selected from an identified plurality of voice commands and identifying the set of preferred local commands further as having a best combined confusion score computed using the plurality of confusion scores and the set of used commands. Identifying the set of preferred local commands as having a best combined confusion score increases accuracy of the set of preferred local commands and thus increases accuracy of one or more responses of the voice-controlled device.

In another implementation form of the first and second aspects, the at least one voice command is identified in at least one audio signal received from at least one audio sensor connected to the at least one hardware processor. Optionally, identifying the at least one voice command in the set of preferred local commands comprises: receiving from the at least one other voice-controlled device at least one other audio signal captured thereby;

identifying in the at least one audio signal at least one other command identified in the at least one other audio signal; and suppressing the at least one other command. Optionally, the at least one command is identified in the at least one audio signal at a primary local audio level. Optionally, the at least one other command is identified in the at least one audio signal at a secondary local audio level. Optionally, the at least one other command is identified in the at least one other audio signal at a remote audio level. Optionally, the primary local audio level is greater than the secondary local audio level and the remote audio level is greater than the secondary local audio level. Suppressing another command identified at a lower audio level than an audio level of the command increases accuracy of identifying the audio command as being directed at the voice-controlled device.

In a further implementation form of the first and second aspects, the at least one other voice-controlled device identifies the at least one voice command at an audio level, and the audio level is greater by at least a threshold audio level than a background audio level identified by the at least one other voice-controlled device. Optionally, the threshold audio level is greater than −15 deciBells (dB). Identifying a command at an audio level greater by at least a threshold relative to another audio level of background audio increases accuracy of identifying the command and thus increases accuracy of a response of the voice-controlled device to the command.

In a further implementation form of the first and second aspects, the at least one hardware processor is further adapted for: identifying in the at least one audio signal at least one remote command directed at the at least one other voice-controlled device, and sending the at least one remote command to the at least one other voice-controlled device. Optionally, the at least one hardware processor is further adapted for sending the set of preferred local commands to the at least one other hardware processor. Optionally, the at least one hardware processor is further adapted for sending the identified at least one voice command to the at least one other voice-controlled device. Sending to another voice-controlled device one or more of the command directed to the voice-controlled device, another command directed at the other voice-controlled device, and the set of preferred local commands, increases accuracy of operation of the other voice-controlled device.

In a further implementation form of the first and second aspects, the at least one hardware processor is further adapted for in at least one of a plurality of iterations: receiving from the at least one other voice-controlled device a new set of used commands; identifying in the plurality of voice commands a new set of preferred local commands not members of the new set of used commands; and responding to at least one new voice command, received from a new user, subject to identifying the at least one new voice command in the new set of preferred local commands, otherwise declining to respond thereto. Receiving from another voice-controlled device another set of used commands allows increasing accuracy of the new set of preferred local commands, thus increasing accuracy of identifying a new voice command.

In a further implementation form of the first and second aspects, the at least one hardware processor is further adapted for: receiving from the at least one other voice-controlled device at least one other remote command identified thereby; and identifying the at least one voice command in the set of preferred local commands by further using the at least one other remote command. Optionally, identifying the at least one voice command in the set of preferred local commands comprises receiving from the at least one other voice-controlled device at least one current command identified by at least one other voice-controlled device. Identifying a voice command using a remote command identified by another voice-controlled device, and additionally or alternatively using a command identified by the other voice-controlled device and addressed thereto, increases accuracy of identifying the voice command, and thus increases accuracy of the device's response to the voice command.

In a further implementation form of the first and second aspects, the at least one hardware processor is further adapted for computing a plurality of statistical values characteristic of the at least one voice command. Optionally, the at least one hardware processor is further adapted for: computing another plurality of confusion scores using the plurality of statistical values; identifying in the plurality of voice commands another set of preferred local commands having another best combined confusion score computed using the other plurality of confusion scores and the set of used commands; and responding to at least one additional voice command, received from another user, subject to identifying the at least one additional voice command in the other set of preferred local commands, otherwise declining to respond thereto. Optionally, at least one of the other set of preferred local commands has a length determined subject to at least one of the plurality of statistical values indicative of a background noise level exceeding an identified noise threshold value. Using statistical values characteristic of one or more voice commands increases accuracy of the set of preferred local commands and thus increases accuracy of identifying the voice command. Optionally, the at least one hardware processor is further adapted for: receiving from at least one additional other voice-controlled device another plurality of statistical values characteristic of at least one additional voice command identified by the at least one additional other voice-controlled device; computing an additional other plurality of confusion scores using the other plurality of statistical values; identifying in the plurality of voice commands an additional other set of preferred local commands having an additional other best combined confusion score computed using the additional other plurality of confusion scores and the set of used commands; and responding to at least one further additional voice command, received from an additional other user, subject to identifying the at least one further additional voice command in the additional other set of preferred local commands, otherwise declining to respond thereto. Updating the set of preferred local commands using another plurality of statistical values increases accuracy of the updated set of preferred local commands, and thus increases accuracy of identifying a new command.

In a further implementation form of the first and second aspects, the other plurality of confusion scores is computed by further using a plurality of voice characteristics identified in the at least one command. Optionally, the at least one hardware processor is further adapted for: associating the other set of preferred local commands with the user, receiving at least one new command from a new user, identifying the new user as the user, and presenting to the new user at least some of the other set of preferred local commands. Optionally, the at least one hardware processor is further adapted for: receiving from the at least one other voice-controlled device a set of user preferred local commands and an identification value indicative of an additional user; computing another identification value indicative of the user; applying at least one test to the identification value and the other identification value to determine whether the user is the additional user; and presenting to the user at least some of the set of user preferred local commands subject to determining the user is the additional user. Associating a set of commands with a user increases accuracy of identifying the command uttered by the user in the set of commands, and thus increases accuracy of a response of the voice-controlled device to the command.

In a further implementation form of the first and second aspects, the at least one hardware processor is further adapted for: receiving at least one video signal, captured by at least one video sensor connected to the at least one hardware processor, capturing the user uttering the at least one voice command; and identifying the at least one voice command in the set of preferred local commands according to the at least one video signal. Optionally, the at least one hardware processor is further adapted for: receiving at least one other video signal, captured by the at least one video sensor when another user utters at least one other voice command; and responding to the at least one other voice command subject to identifying the other user in the at least one other video signal as the user in the at least one video signal, otherwise declining to respond thereto. Using video to identify the user speaking to the voice-controlled device and additionally or alternatively to further identify the command increases accuracy of identifying the command.

In a further implementation form of the first and second aspects, the at least one hardware processor is further adapted for: classifying the at least one command with a first user classification according to one or more voice characteristics identified in the at least one command; classifying at least one yet other command, received from another user, with a second user classification according to one or more other voice characteristics identified in the at least one yet other command; and responding to the at least one yet other voice command, subject to the first user classification being equal to the second user classification, otherwise declining to respond thereto. Identifying a speaker and then responding only to the speaker increases accuracy of identifying other commands uttered by the speaker.

In an implementation form of the fourth and fifth aspect, the at least one hardware processor is further adapted for: computing a plurality of confusion scores, each indicative of a likelihood of confusion between a pair of voice commands selected from a plurality of voice commands, each of the plurality of voice commands having a recognition score indicative of a likelihood of a voice-controlled device recognizing the voice command; identifying the first set of preferred commands by identifying in the plurality of voice commands a set of preferred commands having a best combined confusion score computed using the plurality of confusion scores; and configuring the first voice-controlled device to operate in response to the first set of preferred commands. Optionally, the at least one hardware processor is further adapted for: identifying the second set of preferred commands by identifying in the plurality of voice commands another set of preferred commands having another best combined confusion score computed using the plurality of confusion score and the first set of preferred commands; and configuring the second voice-controlled device to operate in response to the second set of preferred commands. Optionally, identifying the second set of preferred commands comprises declining to add to the second set of preferred commands at least one of the first set of preferred commands. Declining to add to a second set of preferred commands a command already a member of a first set of preferred commands increases accuracy of a distinction between the first set of preferred commands and the second set of preferred commands, thus increasing accuracy of identification of one or more commands by the first voice-controlled device and the second-controlled device.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which embodiments. Although methods and materials similar or equivalent to those described herein can be used in the practice or testing of embodiments, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments are herein described, by way of example only, with reference to the accompanying drawings. With specific reference now to the drawings in detail, it is stressed that the particulars shown are by way of example and for purposes of illustrative discussion of embodiments. In this regard, the description taken with the drawings makes apparent to those skilled in the art how embodiments may be practiced.

In the drawings:

FIG. 1 is a schematic block diagram of an exemplary voice-controlled device, according to some embodiments;

FIG. 2 is a schematic block diagram of an exemplary system, according to some embodiments;

FIG. 3 is a flowchart schematically representing an optional flow of operations for a voice-controlled device, according to some embodiments;

FIG. 4 is a flowchart schematically representing an optional flow of operations for identifying a command, according to some embodiments;

FIG. 5 is a flowchart schematically representing an optional flow of operations for using statistical values, according to some embodiments;

FIG. 6 is a flowchart schematically representing an optional flow of operations for using user awareness, according to some embodiments;

FIG. 7 is a flowchart schematically representing an optional flow of operations for sharing user awareness, according to some embodiments;

FIG. 8 is a flowchart schematically representing an optional flow of operations for using a video signal, according to some embodiments;

FIG. 9 is a flowchart schematically representing another optional flow of operations for using user awareness, according to some embodiments; and

FIG. 10 is a flowchart schematically representing an optional flow of operations for managing a plurality of voice-controlled devices, according to some embodiments.

### DESCRIPTION OF SPECIFIC EMBODIMENTS OF THE INVENTION

Some embodiments described in the present disclosure relate to a voice user interface and, more specifically, but not exclusively, to speech recognition.

An audio signal captured by one or more audio sensors may include, in addition to one or more voice commands, ambient noise of the environment in which the one or more audio sensors are installed. In addition, the audio signal may include one or more other voice commands directed at another voice-controlled device, for example when another voice-controlled device is located close enough to the device such that commands uttered by another user interacting with the other device are captured by the one or more audio sensors of the device. A common example is when a first smartphone, held by a first person, captures a voice command directed by a second user to a second smartphone held thereby. This may cause confusion in operation of the one or more devices, for example when the first device responds to a voice command directed at the second device.

There exist environments where there is a need to install or use a plurality of voice-controlled devices in close proximity, where each of the plurality of devices provides a common set of services. One example is a plurality of interactive kiosks, providing access to information and additionally or alternatively to a plurality of operations, for example a plurality of tourist information kiosks, a plurality of digital menus at a restaurant, or a plurality of vending kiosks. Another example is a plurality of hand held devices, each held by one of a plurality of sales representatives in a showroom.

When two or more devices are configured to respond to a common set of voice commands and are located in such close proximity, operation of at least one of the devices may be compromised. For example, when a first user interacts with a first device, an audio signal processed by a second device may include a command uttered by the first user interacting with the first device, and may cause the second device to recognize the command and respond thereto. It may be undesirable for the second device to respond to the command. In addition, the command may interfere with another interaction between a second user and the second device. For example, when the second device is a vending kiosk the second device may add an unwanted item to a shopping cart. In another example, when the second device is an information kiosk, the second device may display an unrequested image. In addition, the first user and second user speaking simultaneously reduces accuracy of the first device recognizing another command uttered by the first user and directed thereto.

Some existing solutions aim at increasing a likelihood that the command uttered by the first user is not captured in the audio signal processed by the second device, or is captured at an audio level lower than an identified threshold audio level. Some methods to achieve this include increasing a distance between each two devices of the plurality of devices, however these solutions are less effective with a user speaking loudly. Some other methods include reducing sensitivity of a device's audio sensors, reducing a likelihood of the second device's audio sensor capturing the command directed at the first device. Such solutions have a negative impact on accuracy of the device identifying a command directed thereto.

Some embodiments described henceforth propose each of the plurality of devices responding to a separate set of preferred local commands for controlling a common set of operations. Thus, in some embodiments, the first device is configured to respond to a first set of preferred local commands and the second device is configured to respond to a second set of preferred local commands, where the first set of preferred local commands is different from the second set of preferred local commands. Optionally, the first device is configured to execute one or more operations in response to at least one of the first set of preferred local commands, and the second device is configured to execute the one or more operations in response to at least one other of the second set of preferred local commands. For example, when the plurality of devices is a plurality of vending kiosks, the one or more operations optionally comprises adding an item to a list of items selected by the user, for example a shopping cart or a vending application. In another example when the plurality of devices is a plurality of information kiosks, the one or more operations optionally comprises displaying digital data on a display of the information kiosk, Consequently, both the first device and the second device may execute the one or more operations in response to a voice command, however as the first set of preferred local commands is different from the second set of preferred local commands the second device may not respond to a command directed to the first device and the first device may not respond to another command directed to the second device.

Optionally, each of the plurality of voice commands has a recognition score indicative of a likelihood of a voice-controlled device recognizing the voice command. As used henceforth, a recognition score of one command is better than another recognition score of another command when a likelihood of a voice-controlled device identifying the command, as indicated by the recognition score, is higher than another likelihood of the voice-controlled device identifying the other command, as indicated by the other recognition score. Optionally, the first set of preferred local commands and the second set of preferred local commands each have at least some voice commands having better respective recognition scores than other relative recognition scores of at least some other voice commands. That is, at least some of the first set of preferred local commands have respective recognition scores that are better than other respective recognition scores of some of the second set of preferred local commands, and vice versa—at least some other of the second set of preferred local commands have other respective recognition scores that are better than some other respective recognition scores of some other of the first set of preferred local commands.

Optionally, the first device and the second device are configured by at least one hardware processor. Optionally, the first device receives the second set of preferred local commands from the second device and identifies in a plurality of voice commands the first set of preferred local commands such that the first set of preferred local commands are not members of the second set of preferred local commands. Optionally, the first device receives one or more other sets of used commands from one or more other devices and identifies in the plurality of voice commands the first set of preferred local commands such that the first set of preferred local commands are not members of the one or more other sets of used commands. Identifying the first set of preferred local commands not members of the second set of preferred local commands or the one or more other sets of used commands reduces a likelihood of the first device identifying another command not directed thereto and thus increases accuracy of the first device identifying a command received from a user and directed at the first device. Optionally, the first device shares the first set of preferred local commands with one or more other devices, for the purpose of each of the one or more other devices identifying a respective set of preferred local commands.

Optionally, the first set of preferred local commands is identified as having a best combined confusion score computed using a plurality of confusion scores and the second set of preferred local commands. Optionally, each of the confusion scores is indicative of a likelihood of confusion between a pair of voice commands selected from the plurality of voice commands. Optionally, each of the confusion scores is computed using one or more of a plurality of recognition scores of the plurality of voice commands. Optionally, at least one of the plurality of confusion scores is computed using a recognition score of one of the plurality of voice commands when trying to recognize another of the plurality of voice commands and another recognition score of the other voice command when trying to recognize the one voice command. Optionally, the best combined confusion score is indicative of a lowest likelihood of confusion between at least some of the plurality of voice commands. Optionally, the best combined confusion score is a highest combined confusion score identified in a plurality of combined confusion scores. Optionally, the best combined confusion score is a lowest combined confusion score identified in the plurality of combined confusion scores. Optionally, each of the plurality of combined confusion scores is computed by applying at least one combination function to the plurality of confusion scores. Optionally, computing the plurality of combined confusion scores comprises applying one or more matrix multiplications to at least some of the plurality of recognition scores. Optionally, the best combined confusion score is a lowest combined confusion scores identified in the plurality of combined confusion scores. Identifying the first set of preferred local commands as having a best combined confusion score with regards to the second set of preferred local commands reduces a likelihood of the first device identifying another command not directed thereto and thus increases accuracy of the first device identifying a command received from a user and directed at the first device.

In some embodiments, characteristics of commands are used to increase accuracy of identifying a voice command. In such embodiments, the first device computes a plurality of statistical values characteristic of the at least one of the first set of preferred local commands. Some examples of a statistical value characteristic of a command are an amount of times the command was identified correctly, an amount of times the command was falsely identified, and an amount of times the command was not identified. Some examples of another statistical value characteristic of a set of commands are a sum of an amount of times any of the set of commands is identified as another of the set of commands (a mismatch), and a probability of a mismatch of any of the set of commands. Optionally, the first device computes another plurality of combined confusion scores according to the plurality of statistical values. Optionally, the first device computes another set of preferred local commands using the other plurality of combined confusion scores and the second set of preferred local commands. Computing the other set of preferred local commands using the other plurality of combined confusion scores increases accuracy of the first device identifying a new command received from a user.

Optionally, the first device receives from at least one other device another plurality of statistical values characteristic of one or more other commands identified by the at least one other device. Optionally, computing the other set of preferred local commands comprises further using the other plurality of statistical values. Using statistical values received from another device increases accuracy of the first device identifying a new command received from a user.

Optionally, at least one statistical value of the plurality of statistical values is indicative of a background noise level. Optionally, at least one of the other set of preferred local commands has a length which is determined subject to the at least one statistical value exceeding an identified noise threshold value. For example, in a noisy environment a longer word may have a greater likelihood of being identified than a shorter word. In a noisy environment, using a longer word may reduce a likelihood of a false identification. Selecting a command's length according to background noise levels increases accuracy of the first device identifying a new command received from a user.

Optionally, computing the other plurality of confusion scores further comprises using a plurality of voice characteristics identified in at least one of the first set of preferred local commands. Some examples of a voice characteristic are a pitch value, a typical length of a vowel, a typical length of silence, and a difference between an audio level of an identified audio frequency and another audio level of a basic pitch. Optionally, the plurality of voice characteristic is organized in a vector. Optionally, the vector is created by a neural network trained to distinguish between two or more different voices. Optionally at least some of the plurality of voice characteristics are indicative of a difficulty in identifying the at least one of the first set of preferred local commands when pronounced by a user. Analyzing the user's voice to learn which commands might be difficult to identify increases accuracy of the first device identifying a new command received from a user.

In some embodiments, the plurality of devices shares information about commands to improve accuracy of identifying a voice command. In such embodiments, the second device identifies one or more remote commands directed at the first device and shares the one or more remote commands with the first device. Optionally, the first device uses the one or more remote commands received from the second device to identify the at least one of the first set of preferred local commands in an audio signal captured by one or more audio sensors of the first device. Using the one or more remote commands received from the second device to identify the at least one of the first set of preferred local commands increases accuracy of the first device identifying the at least one of the first set of preferred local commands.

Optionally, the second device identifies one or more other commands directed at the second device and shares the one or more other commands with the first device. Optionally, the first device uses the one or more other commands when identifying the at least one of the first set of preferred local commands in the audio signal captured by one or more audio sensors of the first device, for example by suppressing the one or more other commands. Optionally, the second device sends the first device another audio signal, captured by another audio sensor of the second device. Optionally, the first device identifies the one or more other commands in the other audio signal. Suppressing another command directed at another device increases accuracy of the first device identifying the at least one of the first set of preferred local commands.

As used herein, the term “user awareness” means an ability to distinguish one user from one or more other users, without explicitly identifying the one user. Some embodiments use user awareness to improve accuracy of identifying a command. In some embodiments, the other set of preferred local commands is associated with the user. Optionally, in response to receiving a new command from a new user, in such embodiments the first device may identify the new user as the user and optionally the first device presents to the new user at least some of the other set of preferred local commands. Presenting to a user a set of commands associated therewith increases accuracy of the first device identifying one or more new commands of the other set of preferred local commands.

Some embodiments use video to increase accuracy of identifying a command. In such embodiments, the first device includes one or more video sensors, for example a video camera. Optionally, the first device identifies the at least one of the first set of preferred local commands according to a video signal captured by the one or more video sensors, for example according to analysis of lip movements of a user captured in the video signal facing the video sensor. In another example, the first device identifies the at least one of the first set of preferred local commands by inputting the lip movements and the at least one audio signal into a neural network trained to extract a speaker's utterances from an audio signal in response to input comprising the audio signal and a plurality of lip movements of the speaker. Optionally the neural network identifies a correlation between the plurality of lip movements and the speaker's utterances. Using a video signal facilitates determining which of a plurality of commands uttered by a plurality of speakers is directed at the first device, reducing a likelihood of the first device identifying another command not directed thereto and thus increases accuracy of the first device identifying a command received from the user and directed at the first device.

In some embodiments, the first device classifies the user from which the at least one of the first set of preferred local commands is received, and declines responding to a new command received from another user. Optionally, the user is classified according to a video signal captured by the one or more video sensors, for example by detecting the user's gaze at the video sensor and additionally or alternatively by identifying, and additionally or alternatively tracking, lip movements of the user. Optionally, the user is classified according to one or more voice characteristics identified in the at least one of the first set of preferred local commands. Identifying a speaker and then responding only to the identified speaker reduces a likelihood of the first device identifying another command not directed thereto and thus increases accuracy of the first device identifying a command received from the user and directed at the first device.

Before explaining at least one embodiment in detail, it is to be understood that embodiments are not necessarily limited in its application to the details of construction and the arrangement of the components and/or methods set forth in the following description and/or illustrated in the drawings and/or the Examples. Implementations described herein are capable of other embodiments or of being practiced or carried out in various ways.

Embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments.

Aspects of embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

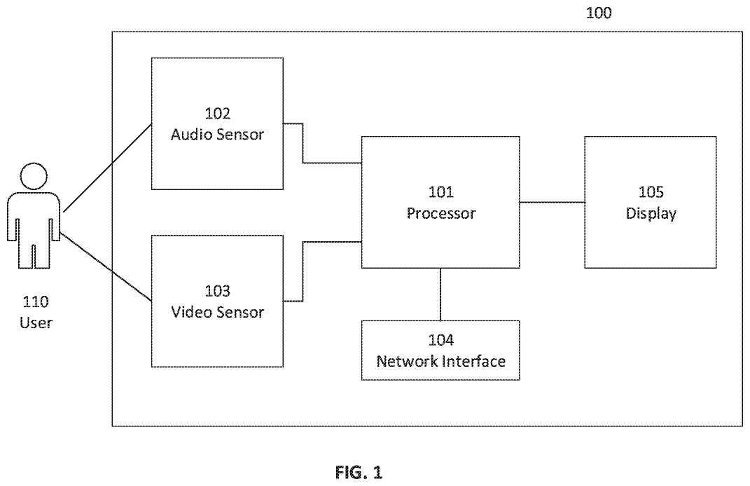

Reference is now made to FIG. 1, showing a schematic block diagram of an exemplary voice-controlled device 100, according to some embodiments. In such embodiments, voice-controlled device 100 comprises at least one hardware processor 101. Optionally, device 100 comprises at least one audio sensor 102 connected to at least one hardware processor 101, optionally to capture one or more commands spoken by user 110. A microphone is an example of an audio sensor.

Optionally, one or more video sensors 103 are connected to at least one hardware processor 101, for example for the purpose of capturing user 101 while speaking the one or more commands. The term video sensor refers to an apparatus configured for capturing a stream of images and handling the stream of images as a video signal. The stream of images may be a stream of digital images. A video sensor may comprise one or more of: an image sensor, a hardware processor, a memory buffer, image processing circuitry, and image processing software. One example of a video senor is a digital video camera.

For brevity, henceforth the term “processing unit” is used to mean “at least one hardware processor”, the term “audio sensor” is used to mean “at least one audio sensor”, and the term “video sensor” is used to mean “at least one video sensor”. The terms are used respectively interchangeably.

Optionally, device 100 comprises one or more display devices 105, connected to processor 101, optionally for the purpose of presenting one or more available commands to user 110. Some examples of a display device are a monitor and a computer screen. Optionally, the one or more available commands are presented as text. Optionally, the one or more available commands are presented as one or more images.

Optionally, device 100 comprises one or more digital communication network interface 104, connected to processor 101. Optionally, device 100 connects via one or more digital communication network interface to one or more of a plurality of voice-controlled devices. Optionally, one or more digital communication network interface 104 is connected to a wired local area network (LAN), for example an Ethernet LAN. Optionally, one or more digital communication network interface 104 is connected to a wireless LAN, for example a Wi-Fi LAN. Optionally, one or more digital communication network interface 104 is connected to a wired is connected to a wide area network (WAN) for example a cellular network or the Internet. Optionally, device 100 is a vending device, for example a vending kiosk.

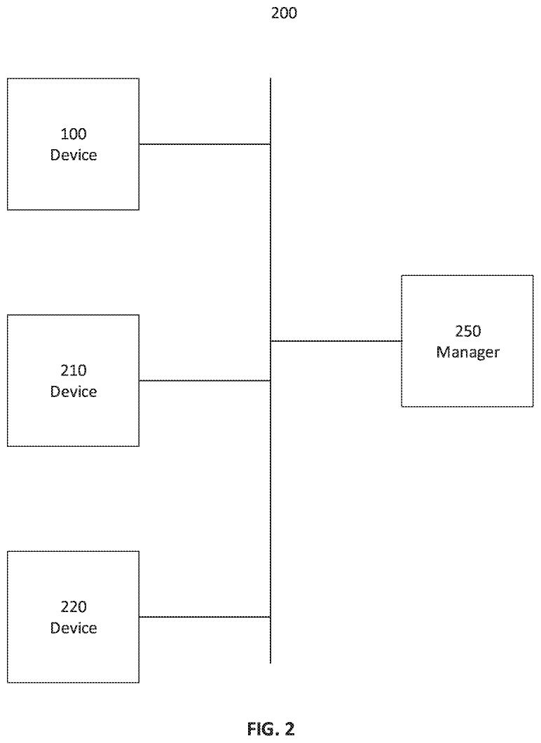

In some embodiments, a system comprises a plurality of voice-controlled devices. Reference is now made also to FIG. 2, showing a schematic block diagram of an exemplary system 200, according to some embodiments. In such embodiments, the system comprises a plurality of devices, for example including device 100, other device 210 and yet other device 220. Optionally, device 100 is connected to others of the plurality of devices via at least one digital communication network interface 104. Optionally, the plurality of devices communicates with each other. Optionally, system 200 comprises at least one manager hardware processor 250, henceforth referred to as manager 250, optionally for the purpose of configuring the plurality of devices.

In some embodiments, device 100 implements the following optional method.

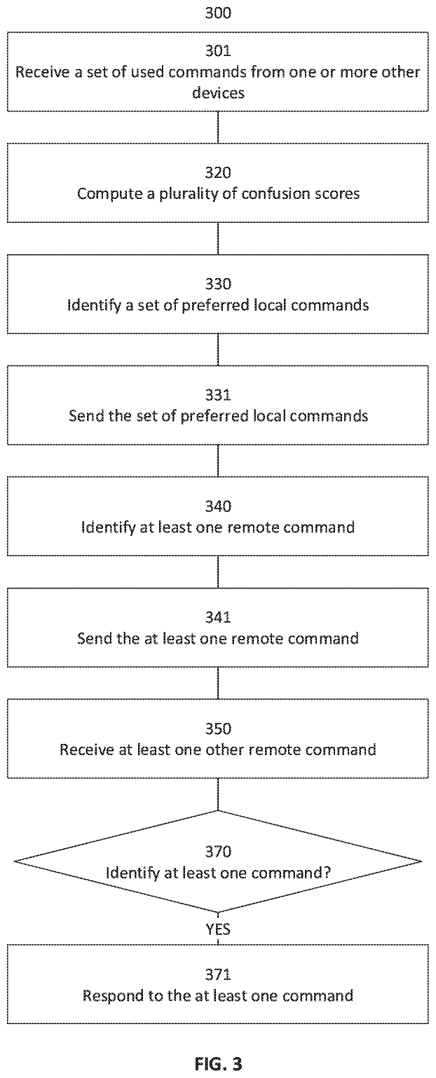

Reference is now made also to FIG. 3, showing a flowchart schematically representing an optional flow of operations 300 for a voice-controlled device, according to some embodiments. Optionally, processor 101 receives a set of preferred local commands from manager 250. Optionally, processor 101 computes the set of preferred local commands. Optionally, the set of preferred local commands are computed according to a plurality of voice commands. Optionally, each of the plurality of voice commands is a possible command that device 100 may add to the set of preferred local commands. Optionally, in 301 processor 101 receives a set of used commands from one or more other devices, for example from other device 210. Optionally, set of used commands are used by other device 210. In 330, processor 101 optionally identifies the set of preferred local commands in a plurality of voice commands. Optionally, the set of preferred local commands are not members of the set of used commands. In such embodiments, the set of preferred local commands of device 100 is different from the set of used commands used by other device 210. Optionally, each of the plurality of voice commands has a recognition score indicative of a likelihood of a voice-controlled device recognizing the voice command. Optionally, processor 101 identifies the set of preferred local commands such that at least some of the set of preferred local commands each have a respective recognition score better than some other recognition scores of some of the set of used commands.

Processor 101 optionally receives at least one voice command, optionally from user 110. Optionally, processor 101 identifies the at least one command in one or more audio signals received from audio sensor 102. In 370, processor 101 optionally identifies the at least one command in the set of preferred local commands. Subject to identifying the at least one command in the set of preferred local commands, in 371 processor 101 optionally responds to the at least one command. For example, when device 100 is a vending device, processor 101 may respond to the at least one command by adding an item to a list of selected items, for example a digital shopping cart. In another example, when device 100 is an information kiosk, processor 101 may respond to the at least one command by presenting a text on one or more display device 105. Optionally, subject to failing to identify the at least one command in the set of preferred local commands, processing unit 101 declines to respond to the at least one command.

Optionally, each command of the plurality of voice commands has a recognition score, indicative of a likelihood of device 100 recognizing the command. Optionally, in 320 processor 101 computes a plurality of confusion scores, each indicative of a likelihood of confusion between a pair of commands selected from an identified plurality of voice commands. Optionally, the identified plurality of voice commands is selected from the plurality of voice commands, optionally according to a plurality of respective recognition scores thereof. For example, the identified plurality of voice commands may be an identified amount of commands of the plurality of voice commands having highest respective recognition scores, for example 20 highest scoring commands.

Optionally, computing the plurality of confusion scores in 320 comprises computing a plurality of multiplications between each respective recognition score of each of the identified plurality of commands and each other respective recognition score of each of the set of used commands. Optionally, computing the plurality of confusion scores comprises one or more matrix multiplication operations, optionally using one or more matrices comprising at least some of the respective recognition scores of the plurality of commands.

Optionally, processor 101 computes a combined confusion score for each of one or more subsets of the identified amount of commands. Optionally, each combined confusion score is computed using the plurality of confusion scores computed using the set of used commands. Optionally, processor 101 identifies the set of preferred local commands in 330 further as one or the one or more subsets having a best combined confusion score. Optionally, a best combined confusion score is identified by applying one or more tests to a plurality of confusion scores. Optionally, the best combined confusion score is a lowest confusion score identified in the plurality of confusion scores. Optionally, the best combined confusion score is a highest confusion score identified in the plurality of confusion scores. Optionally, the best combined confusion score is a lowest confusion score identified in the plurality of confusion scores.

Optionally, in 331 processor 101 sends the set of preferred local commands to other device 210, optionally for the purpose of device 210 updating the set of used commands. Optionally, processor 101 sends the set of preferred local commands to one or more additional devices, for example additional other device 220.

Optionally, device 100 and other device 210 are installed in close proximity such that each captures one or more utterances directed at the other at a loud enough audio level to be distinguished from background noise. For example, optionally other device 210 identifies the one or more commands, directed at device 100, at an audio level. Optionally, other device 210 identifies a background audio level. Optionally, the audio level that other device 210 identifies the one or more commands directed at device is greater than the background audio level by at least a threshold audio level, for example by at least by −15 deciBells (dB).

Device 100 may use an additional command captured by another device, for example other device 210, to increase accuracy of identifying the one or more commands and additionally or alternatively of whether the one or more commands are directed thereto. Device 100 may use an additional command directed at other device 210 to decline responding to the one or more commands. When the one or more commands are directed at device 100, device 100 may use an additional command captured by other device 210 to increase confidence of identifying the one or more commands and responding thereto.

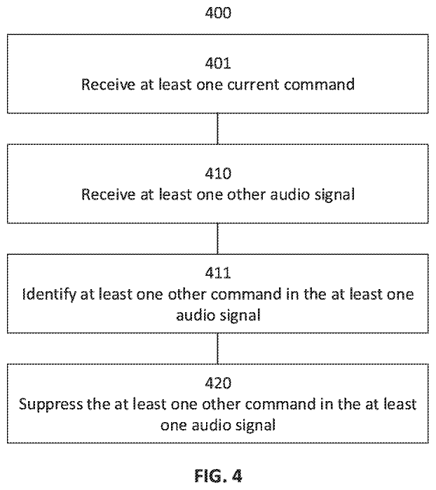

Reference is now made also to FIG. 4, showing a flowchart schematically representing an optional flow of operations 400 for identifying a command, according to some embodiments. In 410, processor 101 optionally receives from other device 210 one or more other audio signals, optionally captured by other device 210. Optionally, processor 101 receives from other device 210 a textual representation of at least part of the one or more other audio signals. Optionally, processor 101 identifies one or more external commands in the one or more audio signals. In 411, processor 101 optionally identifies the one or more external commands in the one or more audio signals, captured by audio sensor 102. Optionally, processor 101 identifies the one or more commands in the one or more audio signals at a primary local audio level, and optionally identifies the one or more external commands in the one or more audio signals at a secondary audio level. When the one or more external commands are directed at other device 210 and not directed at device 100, the primary local audio level may be greater than the secondary local audio level, i.e. processor 101 optionally identifies the one or more commands louder than the one or more external commands. Optionally, processor 101 identifies the one or more external command in the one or more other audio signals at a remote audio level. When the one or more external commands are directed at other device 210 and not directed at device 100, the remote audio level may be greater than the secondary local audio level, i.e. other device 210 optionally identifies the one or more external commands louder than device 100 identifies the one or more external commands. Optionally, in 420 processor 101 suppresses the one or more external commands in the one or more audio signals, for example when the one or more external commands are not directed at device 100. Optionally, processor 101 suppresses the one or more external commands using one or more echo cancellation techniques.

Optionally, other device 210 identifies the one or more external commands in the one or more other audio signals and sends the one or more external commands to device 100. Optionally, the one or more external commands are one or more current commands directed at other device 210. In 401, processor 101 optionally receives from other device 210 the one or more current commands identified by other device 210. Optionally, processor 101 suppresses the one or more current commands in the one or more audio signals.

Reference is now made again to FIG. 3. Optionally, the one or more external commands are directed at device 100. In 350 processor 101 optionally receives the one or more external commands from other device 210. Optionally, processor 101 identifies the one or more commands in 370 by further using the one or more external commands received from device 210.

In 340 processor 101 optionally identifies in the one or more audio signals captured by audio sensor 102 one or more remote commands, for example one or more remote commands directed to other device 210. Optionally, the one or more remote commands are spoken by another user. In 341 processor 101 optionally sends the one or more remote commands to other device 210. Optionally, processor 101 sends the one or more commands to other device 210. Optionally, other device 210 uses the one or more commands received from processor 101 when identifying the one or more remote commands in the set of used commands. Optionally, processor 101 sends a textual representation of the one or more commands. Optionally, processor 101 sends at least part of the one or more audio signals. Optionally, processor 101 sends a processed audio signal computed from the one or more audio signals.

In some embodiments, accuracy of identifying the one or more commands is increased using a plurality of statistical values.

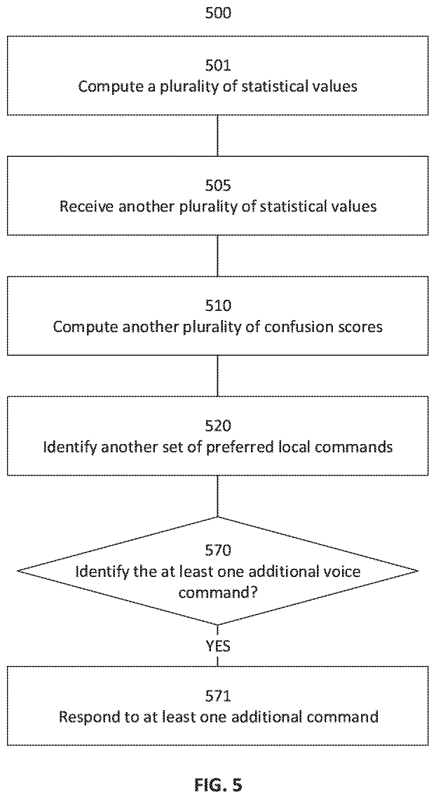

Reference is now made also to FIG. 5, showing a flowchart schematically representing an optional flow of operations 500 for using statistical values, according to some embodiments. In such embodiments, in 501 processor 101 computes a plurality of statistical values characteristic of the one or more voice commands. Optionally, in 510 processor 101 computes another plurality of confusion scores using the plurality of statistical values. Optionally, processor 101 computes the other plurality of confusion scores by further using a plurality of voice characteristics identified in the one or more voice commands, for example one or more voice characteristics indicative of a difficulty to say the one or more voice commands. Optionally, processor 101 computes a plurality of other combined confusion scores using the other plurality of confusion scores. Optionally, each combined confusion scores is computed for one of another plurality of subsets of the plurality of voice commands. In 520, processor 101 optionally identifies in the plurality of voice commands another set of preferred local commands. Optionally, the other set of preferred local commands is identified as having another best combined confusion score of the plurality of other combined confusion scores. Optionally, at least one of the statistical values is indicative of a background noise level exceeding an identified noise threshold value. Optionally, at least one of the other set of preferred local commands has a length determined by the at least one statistical value.

Optionally, processor 101 receives one or more additional commands, optionally from another user. In 570, processor 101 optionally identifies the one or more additional commands in the other set of preferred local commands. Optionally, subject to identifying the one or more additional commands in the other set of preferred local commands, in 571 processor 101 responds to the one or more additional commands. When failing to identify the one or more additional commands in the other set of preferred local commands in 570, in 571 processor 101 optionally declines to respond to the one or more additional commands.

Optionally, in 505 processor 101 receives another plurality of statistical values characteristic of one or more additional voice commands identified by additional other device 220. Optionally, processor 101 repeats 510, 520, 570 and 571 using the other plurality of statistical values in addition or alternatively to using the plurality of statistical values computed in 501.

In some embodiments, user awareness is used to increase accuracy of identifying the one or more commands.

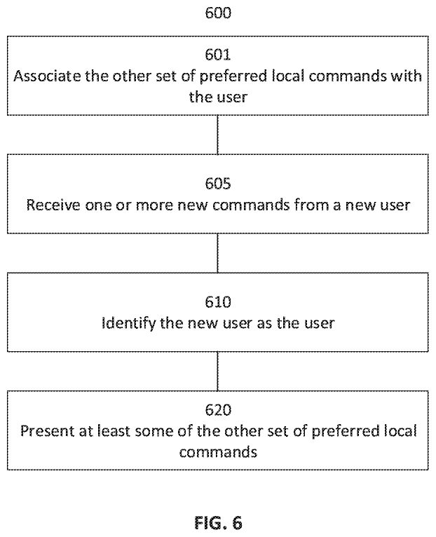

Reference is now made also to FIG. 6, showing a flowchart schematically representing an optional flow of operations 600 for using user awareness, according to some embodiments. In such embodiments, in 601 processor 101 associates the other set of preferred local commands with user 110. Optionally, in 605 processor 101 receives one or more new commands from a new user. In 610 processor 101 identifies the new user as user 110 and 620 optionally presents at least some of the other set of preferred local commands to the new user. Optionally, processor 101 presents the at least some of the other set of preferred local commands on one or more display device 105.

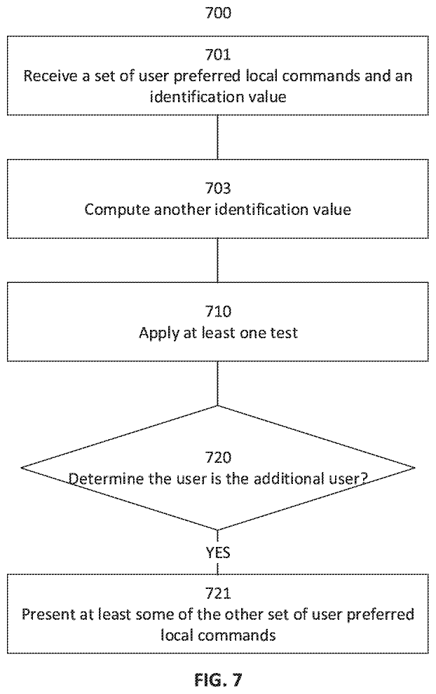

Reference is now made also to FIG. 7, showing a flowchart schematically representing an optional flow of operations 700 for sharing user awareness, according to some embodiments. In such embodiments, in 701 processor 101 receives from other device 210 a set of user preferred local commands and an identification value indicative of an additional user. Optionally, In 703, processor 101 computes another identification value indicative of user 110. In 710, processor 101 optionally applies one or more tests to the identification value and the other identification value to determine whether the additional user is user 110. In 720 processor 101 optionally determines whether the additional user is user 110, and subject to such determination in 721 processor 101 optionally presents to the user at least some of the set of user preferred local commands, optionally on one or more display device 105.

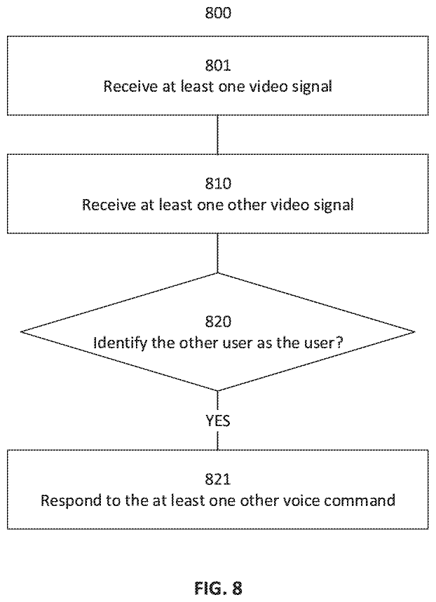

In some embodiments, video is used to increase accuracy of identifying the one or more commands. Reference is now made also to FIG. 8, showing a flowchart schematically representing an optional flow of operations 800 for using a video signal, according to some embodiments. In such embodiments, processor 101 receives in 801 one or more video signals, optionally captured by video sensor 103. Optionally the one or more video signals capture user 110 uttering the one or more commands. Optionally, processor 101 identifies the one or more commands in 370 according to the one or more video signal. For example, processor 101 may identify one or more lip movements of a user captured in the one or more video signals, optionally when the user faces video sensor 103, and optionally computes a likelihood of a match between the one or more lip signals and the one or more commands. Optionally, processor 101 provides the one or more video signals and one or more audio signals to a neural network. Optionally, the neural network is executed by processor 101.

There may be a need to respond, at least for an identified period of time after responding to the one or more commands from user 110, only to command from user 110. For example, to reduce a likelihood of two users uttering conflicting commands. Optionally, in 810 processor 101 receives one or more other video signals captured by video sensor 103 when another user utters one or more other commands. In 820, processor 101 optionally identifies the other user as user 110. Optionally, subject to identifying the other user as user 110, in 821 processor 101 responds to the one or more other voice commands.

In order to respond, at least for an identified period of time after responding to a command from an identified user, only to commands from the identified user, in some embodiments device 100 further implements the following method.

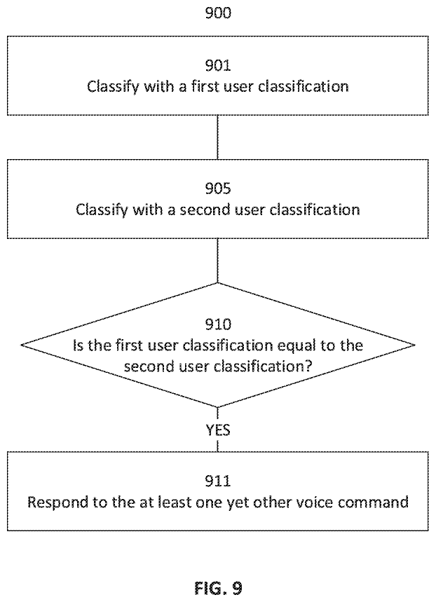

Reference is now made also to FIG. 9, showing a flowchart schematically representing another optional flow of operations 900 for using user awareness, according to some embodiments. In such embodiments, in 901 processor 101 classifies the one or more commands with a first user classification according to one or more voice characteristics identified in the one or more commands. Optionally, in 905, processor 101 classifies one or more yet other commands, received from another user, with a second user classification according to one or more other voice characteristics identified in the one or more yet other commands. In 910 processor 101 optionally identifies the first user classification is equal to the second user classification, indicating a likelihood that the other user is user 110. Optionally, subject to identifying the first user classification is equal to the second user classification in 911 processor 101 responds to the one or more yet other commands. Optionally, the first user classification is computed according to the one or more video signals, for example according to lip movements and additionally or alternatively a gaze detected in the one or more video signals. Optionally, the second user classification is computed according to the one or more other video signals, for example according to other lip movements and additionally or alternatively another gaze detected in the one or more other video signals.

Reference is now made again to FIG. 3.

Optionally, method 300 is repeated in each of a plurality of iterations such that in at least one of the plurality of iterations processor 101 optionally receives from other device 201 a new set of used commands. Optionally, processor 101 identifies in the plurality of voice commands a new set of preferred local commands not members of the new set of user commands. Optionally, processor 101 responds to one or more new voice commands received from a new user. Optionally processor 101 responds to the one or more new voice commands subject to identifying the one or more new voice commands in the new set of preferred local commands. Otherwise, processor 101 optionally declines to respond to the one or more new voice commands. Optionally, processor 101 sends the new set of preferred local commands to other device 210.

Optionally, at least some of the plurality of iterations is executed periodically. Optionally, the new set of preferred local commands is identified after completion of a session with user 110. Optionally, the new set of preferred local commands is identified in response to identifying a change in one or more statistical values indicative of background noise. Optionally, the new set of preferred local commands is identified when the one or more commands comprise an identified command.

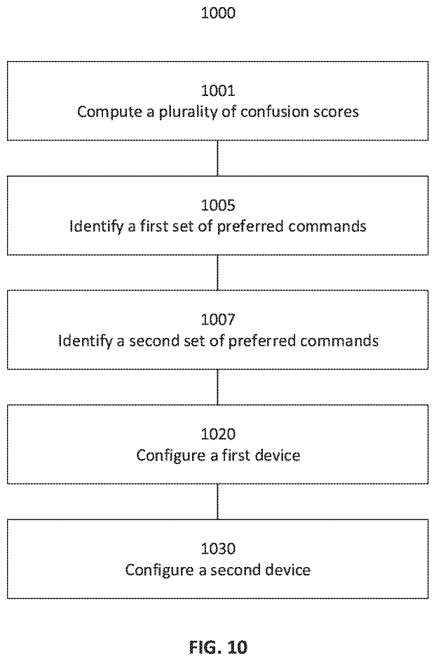

In some embodiments where the plurality of devices are each configured by manager 250, system 300 optionally implements the following method. Reference is now made also to FIG. 10, showing a flowchart schematically representing an optional flow of operations 1000 for managing a plurality of voice-controlled devices, according to some embodiments. In such embodiments, in 1020 manager 250 configures device 100 to execute at least one operation in response to at least one command of a first set of preferred local commands. Optionally, manager 250 identifies the first set of preferred local commands in the plurality of voice commands. Optionally, in 1030 processor 101 configures other device 210 to execute the at least one operation in response to at least one other command of a second set of preferred local commands. Optionally, manager 250 identifies the second set of preferred local commands in the plurality of voice commands. Optionally, the at least one command is different from the at least one other command.

Optionally, in 1001 manager 250 computes a plurality of confusion scores, each indicative of a likelihood of confusion between a pair of voice commands selected from the plurality of voice commands. Optionally, manager 250 computes a plurality of combined confusion scores, one for each of a plurality of subsets of the plurality of voice command. Optionally, each combined confusion score is computed using at least some of the plurality of confusion scores.

In 1005, manager 250 optionally identifies the first set of preferred commands by identifying in the plurality of voice commands one of the plurality of subsets as a set of preferred commands having a best combined confusion score. Optionally, configuring device 100 in 1020 comprises configuring device 100 to operate in response to the first set of preferred commands.

In 1007, manager 250 optionally identifies the second set of preferred commands by identifying in the plurality of voice commands one other of the plurality of subsets as another set of preferred commands having another best combined confusion score. Optionally, the plurality of confusion scores and the plurality of combined confusion scores are used to distribute at least some of the plurality of voice commands between the plurality of devices. Optionally, in 1007 manager 250 declines to add to the second set of preferred command one or more of the first set of preferred commands. Optionally, configuring other device 210 in 1030 comprises configuring other device 210 to operate in response to the second set of preferred commands.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant voice-controlled devices will be developed and the scope of the term voice-controlled device is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment may include a plurality of “optional” features unless such features conflict.

Throughout this application, various embodiments may be presented in a range format. It should be understood that the description in range format is merely for convenience and brevity and should not be construed as an inflexible limitation on the scope of embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of embodiments, which are, for clarity, described in the context of separate embodiments, may also be provided in combination in a single embodiment. Conversely, various features of embodiments, which are, for brevity, described in the context of a single embodiment, may also be provided separately or in any suitable subcombination or as suitable in any other described embodiment. Certain features described in the context of various embodiments are not to be considered essential features of those embodiments, unless the embodiment is inoperative without those elements.

Although embodiments have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A voice-controlled device, comprising at least one hardware processor adapted for:
receiving from at least one other voice-controlled device a set of used commands;
identifying in a plurality of voice commands a set of preferred local commands not members of the set of used commands; and
responding to at least one voice command, received from a user, subject to identifying the at least one voice command in the set of preferred local commands, otherwise declining to respond thereto.

2. The voice-controlled device of claim 1,
wherein each of the plurality of voice commands has a recognition score indicative of a likelihood of the voice-controlled device recognizing the voice command; and
wherein the at least one hardware processor is further adapted for:
computing a plurality of confusion scores, each indicative of a likelihood of confusion between a pair of voice commands selected from an identified plurality of voice commands; and
identifying the set of preferred local commands further as having a best combined confusion score computed using the plurality of confusion scores and the set of used commands.

3. The voice-controlled device of claim 1, wherein the at least one voice command is identified in at least one audio signal received from at least one audio sensor connected to the at least one hardware processor.

4. The voice-controlled device of claim 1, wherein the at least one hardware processor is further adapted for:
identifying in the at least one audio signal at least one remote command directed at the at least one other voice-controlled device; and
sending the at least one remote command to the at least one other voice-controlled device.

5. The voice-controlled device of claim 1, wherein the at least one other voice-controlled device identifies the at least one voice command at an audio level; and
wherein the audio level is greater by at least a threshold audio level than a background audio level identified by the at least one other voice-controlled device.

6. The voice-controlled device of claim 5, wherein the threshold audio level is greater than −15 deciBells (dB).

7. The voice-controlled device of claim 1, wherein the at least one hardware processor is further adapted for sending the set of preferred local commands to the at least one other hardware processor.

8. The voice-controlled device of claim 1, wherein the at least one hardware processor is further adapted for sending the identified at least one voice command to the at least one other voice-controlled device.

9. The voice-controlled device of claim 1, wherein identifying the at least one voice command in the set of preferred local commands comprises receiving from the at least one other voice-controlled device at least one current command identified by at least one other voice-controlled device.

10. The voice-controlled device of claim 3, wherein identifying the at least one voice command in the set of preferred local commands comprises:
receiving from the at least one other voice-controlled device at least one other audio signal captured thereby;
identifying in the at least one audio signal at least one other command identified in the at least one other audio signal; and
suppressing the at least one other command.

11. The voice-controlled device of claim 10,
wherein the at least one command is identified in the at least one audio signal at a primary local audio level;
wherein the at least one other command is identified in the at least one audio signal at a secondary local audio level;
wherein the at least one other command is identified in the at least one other audio signal at a remote audio level; and
wherein:
the primary local audio level is greater than the secondary local audio level; and
the remote audio level is greater than the secondary local audio level.

12. The voice-controlled device of claim 1, wherein the at least one hardware processor is further adapted for computing a plurality of statistical values characteristic of the at least one voice command.

13. The voice-controlled device of claim 12, wherein the at least one hardware processor is further adapted for:
computing another plurality of confusion scores using the plurality of statistical values;
identifying in the plurality of voice commands another set of preferred local commands having another best combined confusion score computed using the other plurality of confusion scores and the set of used commands; and
responding to at least one additional voice command, received from another user, subject to identifying the at least one additional voice command in the other set of preferred local commands, otherwise declining to respond thereto.

14. The voice-controlled device of claim 13, wherein at least one of the other set of preferred local commands has a length determined subject to at least one of the plurality of statistical values indicative of a background noise level exceeding an identified noise threshold value.

15. The voice-controlled device of claim 13, wherein the other plurality of confusion scores is computed by further using a plurality of voice characteristics identified in the at least one command.

16. The voice-controlled device of claim 13, wherein the at least one hardware processor is further adapted for:
associating the other set of preferred local commands with the user;
receiving at least one new command, from a new user;
identifying the new user as the user; and
presenting to the new user at least some of the other set of preferred local commands.

17. The voice-controlled device of claim 13, wherein the at least one hardware processor is further adapted for:
receiving from the at least one other voice-controlled device a set of user preferred local commands and an identification value indicative of an additional user;
computing another identification value indicative of the user;
applying at least one test to the identification value and the other identification value to determine whether the user is the additional user; and
presenting to the user at least some of the set of user preferred local commands subject to determining the user is the additional user.

18. The voice-controlled device of claim 1, wherein the at least one hardware processor is further adapted for:
receiving from at least one additional other voice-controlled device another plurality of statistical values characteristic of at least one additional voice command identified by the at least one additional other voice-controlled device;
computing an additional other plurality of confusion scores using the other plurality of statistical values;
identifying in the plurality of voice commands an additional other set of preferred local commands having an additional other best combined confusion score computed using the additional other plurality of confusion scores and the set of used commands; and
responding to at least one further additional voice command, received from an additional other user, subject to identifying the at least one further additional voice command in the additional other set of preferred local commands, otherwise declining to respond thereto.

19. The voice-controlled device of claim 1, wherein the at least one hardware processor is further adapted for in at least one of a plurality of iterations:
receiving from the at least one other voice-controlled device a new set of used commands;
identifying in the plurality of voice commands a new set of preferred local commands not members of the new set of used commands; and
responding to at least one new voice command, received from a new user, subject to identifying the at least one new voice command in the new set of preferred local commands, otherwise declining to respond thereto.

20. The voice-controlled device of claim 1, wherein at least one hardware processor is further adapted for:
receiving at least one video signal, captured by at least one video sensor connected to the at least one hardware processor, capturing the user uttering the at least one voice command; and
identifying the at least one voice command in the set of preferred local commands according to the at least one video signal.

21. The voice-controlled device of claim 20, wherein the at least one hardware processor is further adapted for:
receiving at least one other video signal, captured by the at least one video sensor when another user utters at least one other voice command; and
responding to the at least one other voice command subject to identifying the other user in the at least one other video signal as the user in the at least one video signal, otherwise declining to respond thereto.

22. The voice-controlled device of claim 1, wherein the at least one hardware processor is further adapted for:
classifying the at least one command with a first user classification according to one or more voice characteristics identified in the at least one command;
classifying at least one yet other command, received from another user, with a second user classification according to one or more other voice characteristics identified in the at least one yet other command; and
responding to the at least one yet other voice command, subject to the first user classification being equal to the second user classification, otherwise declining to respond thereto.

23. The voice-controlled device of claim 1, wherein the at least one hardware processor is further adapted for:
receiving from the at least one other voice-controlled device at least one other remote command identified thereby; and
identifying the at least one voice command in the set of preferred local commands by further using the at least one other remote command.

24. A method for a voice-controlled device, comprising at least one hardware processor adapted for:
receiving from at least one other voice-controlled device a set of used commands;
identifying in a plurality of voice commands a set of preferred local commands not members of the set of used commands; and
responding to at least one voice command, received from a user, subject to identifying the at least one voice command in the set of preferred local commands, otherwise declining to respond thereto.

25. A vending device, comprising at least one hardware processor connected to at least one audio sensor and adapted for:
receiving from at least one other vending device a set of used commands;
identifying in a plurality of voice commands a set of preferred local commands not members of the set of used commands; and
subject to identifying at least one voice command, received from a user via the at least one audio sensor, in the set of preferred local commands, adding an item to a list of items selected by the user, otherwise declining to respond thereto.

26. A system for managing a plurality of voice-controlled devices, comprising at least one hardware processor adapted for:
configuring a first voice-controlled device of the plurality of voice-controlled devices to execute at least one operation in response to at least one of a first set of preferred local commands identified in a plurality of voice commands; and
configuring a second voice-controlled device of the plurality of voice-controlled devices to execute the at least one operation in response to at least one other of a second set of preferred local commands identified in the plurality of voice commands;
wherein the at least one of the first set of preferred local commands is different from the at least one other of the second set of preferred local commands.

27. The system of claim 26, wherein the at least one hardware processor is further adapted for:
computing a plurality of confusion scores, each indicative of a likelihood of confusion between a pair of voice commands selected from a plurality of voice commands, each of the plurality of voice commands having a recognition score indicative of a likelihood of a voice-controlled device recognizing the voice command;
identifying the first set of preferred commands by identifying in the plurality of voice commands a set of preferred commands having a best combined confusion score computed using the plurality of confusion scores; and
configuring the first voice-controlled device to operate in response to the first set of preferred commands.

28. The system of claim 27, wherein the at least one hardware processor is further adapted for:
identifying the second set of preferred commands by identifying in the plurality of voice commands another set of preferred commands having another best combined confusion score computed using the plurality of confusion score and the first set of preferred commands; and
configuring the second voice-controlled device to operate in response to the second set of preferred commands.

29. The system of claim 26, wherein identifying the second set of preferred commands comprises declining to add to the second set of preferred commands at least one of the first set of preferred commands.

30. A method for managing a plurality of voice-controlled devices, comprising:
configuring a first voice-controlled device of the plurality of voice-controlled devices to execute at least one operation in response to at least one of a first set of preferred local commands identified in a plurality of voice commands; and
configuring a second voice-controlled device of the plurality of voice-controlled devices to execute the at least one operation in response to at least one other of a second set of preferred local commands identified in a plurality of voice commands;
wherein the at least one of the first set of preferred local commands is different from the at least one other of the second set of preferred local commands.
